(19) United States
(12) Patent Application Publication
(10) Pub. No.: US 2013/0165556 A1
(43) Pub. Date: Jun. 27, 2013

(54) HIGHLY SCRATCH RESISTANT ONE-PART CLEAR COATING COMPOSITION COMPRISING SILANE-MODIFIED BLOCKED ISOCYANATE FOR CARS

(71) Applicants: Seung-Man Noh, Youngin-si (KR); Jae-Woo Lee, Cheonan-si (KR); Joon-Hyun Nam, Cheonan-si (KR); Hyun-Wook Jung, Seoul (KR)

(72) Inventors: Seung-Man Noh, Youngin-si (KR); Jae-Woo Lee, Cheonan-si (KR); Joon-Hyun Nam, Cheonan-si (KR); Hyun-Wook Jung, Seoul (KR)

(21) Appl. No.: 13/335,800

(22) Filed: Dec. 22, 2011

(51) Int. Cl. C09D 133/00; C08K 5/3475; C08K 5/101; C08K 5/07; C08K 5/3465; C09D 183/04; C08K 5/3445

(52) U.S. Cl. 524/89; 524/506; 524/91; 524/106; 524/359; 524/315; 524/317

(57) ABSTRACT

The present invention relates to a highly scratch resistant one-part clear coating composition comprising a silane-modified blocked isocyanate for cars, in which a blocked isocyanate curing system comprising a silane functional group is applied besides an acrylic melamine-curing system used as a clear coat system for new cars unlike an acrylic-melamine curing clear coat used as a general clear coat for cars such that the formation of scratches on the surface of a car occurring during the automatic or manual car wash is minimized to maintain initial gloss for as long as possible, thereby maintaining the intrinsic color of the car as well as increasing a degree of consumer's satisfaction with the outer appearance of the car.

### TECHNICAL FIELD

The present invention relates to a highly scratch resistant one-part clear coating composition comprising a silane-modified blocked isocyanate for cars, in which a blocked isocyanate curing system comprising a silane functional group is applied besides an acrylic melamine-curing system used as a clear coat system for new cars unlike an acrylic-melamine curing clear coat used as a general clear coat for cars such that the formation of scratches on the surface of a car occurring during the automatic or manual car wash is minimized to maintain initial gloss for as long as possible, thereby maintaining the intrinsic color of the car as well as increasing a degree of consumer's satisfaction with the outer appearance of the car.

### BACKGROUND ART

In case of paints for new cars applied to automobiles, many attempts have been made to intensively research and develop the appearance and physical property requirements of the paints and the paints have been commercialized since the 1980s. However, there is a need for the development of products that can implement appearance, physical properties, and environmentally-friendly property with the advent of the demand for environmentally friendly products since the 1990s. Particularly, the need for the development of a very hard clear coat with acid resistance which can prevent a coat film from being etched by acid rain and chemical erosion as a cause of an external environmental pollution was a central theme in the 2000s. In addition, a serious problem of scratches randomly occurring during the manual car wash of high-class cars contributes to considerable decreases in brand values and export competitiveness of domestic automobiles, and thus there is an urgent need for the development of a clear coat system for finished vehicles, which can overcome such a problem.

A clear coat for automobiles is a transparent paint system applied to a finishing process of a coating system for new cars. Conventionally, a one-part acrylic-melamine and urethane/melamine system has been mainly used as the transparent paint system. However, since such a conventional one-part acrylic-melamine and urethane/melamine system has unsatisfactory physical and chemical properties such as acid resistance, scratch resistance, etc., it causes dissatisfaction to consumers who finally purchase cars. In particular, a problem of scratch resistance of finished vehicles exported to North America becomes a big issue, which reaches a level of demanding the exchange and claim of products.

Thus, the present invention is based on the demand of Korea finished vehicle manufacturers for a more precise curing system that can simultaneously provide a high crosslinking density as well as and acid resistance and scratch resistance which are better than those of an acrylic-melamine crosslinking clear coat applied to an existing finished vehicle.

In a method of improving scratch resistance using silane, which has been developed up to now, since an alkoxide group (—OR) is not mixed with water, when it is substituted with a hydroxyl group using alcohol, SiOH groups produce by-products such as water while forming an Si—O—Si bond through self-condensation. A key technique for an existing clear coat for cars, prepared by a sol-gel reaction process, is to control the reversible reaction of hydrolysis so that it does occur no longer by removing the thus produced water. However, in such a clear coat technique, a problem of hydrolysis reaction and storage stability needs to be improved, and the scratch resistance is relatively not improved as compared to an existing acrylic-melamine clear curing system.

A clear coat which is currently most commonly used in paints for cars is a curing system composed of acrylic melamine resin. A process of applying a clear coat for cars is carried out after a process of applying a top/base coat providing the color of automobiles and comprises curing the applied clear coat at 150° C. for 30 minutes to form a clear film. In the curing system of such a structure, hydrolysis by water, a reduction in the gloss of the film after the occurrence of scratches, and the resulting deterioration in restoration properties are the biggest problems. Most automobile manufacturers have improved the functionality of the clear films for cars using a two-part clear coat having excellent weather resistance and functionality, but have caused considerable inconvenience in terms of a worker's workability or management after work in an actual coating line due to unstable working time.

As mentioned above, a problem occurs in an existing one-part acrylic-melamine clear coat, and thus a silane-modified blocked isocyanate curing system becomes as a technical alternative to such a one-part clear coat for new cars. Thus, the present invention is designed to overcome the disadvantage of such two-part clear coat or the clear coat comprising a silane-modified acrylic resin and simultaneously realize an urethane bond and a silane network by substituting a blocked isocyanate, but not a main resin, with an Si functional group, thereby remarkably improving the scratch resistance.

As examples of a technique for forming a clear coat using silane, there is disclosed Korean Patent Registration No. 127783 entitled “One-Component Paint Composition for Automobiles”. The one-component paint composition comprises a blocked isocyanate resin prepared by masking an acrylic resin and an aliphatic isocyanate with a blocking agent and then modifying the masked mixture with alcohols wherein the acrylic resin is prepared by solution-polymerizing an acrylic monomer containing a general acrylic monomer, a carboxyl group, a hydroxyl group, and a silane group, and the amount of the blocked isocyanate resin is within the range of 0.9-1.5 equivalent weight relative to 1 equivalent weight of the acrylic resin.

Also, the one-component paint composition is good in solvent resistance, chemical resistance, heat resistance, and weather resistance. As another example of a technique for forming a clear coat using silane, there is disclosed Korean Patent Registration No. 596514 entitled “Paint Composition for Automobiles”. The paint composition comprises 28-50 wt % of an acrylic polyol, 15-40 wt % of a silane-modified polyol, 9-30 wt % of a triazine curing agent, and 1-5 wt % of an acid catalyst wherein the silane-modified polyol is obtained by reacting any one compound selected from the an acrylic modified polyester resin represented by the structure of the following Formula 1, polycaprolactone polyol, and polycarbonate polyol with an isocyanate-functional silane compound, and the paint composition is characterized by being excellent in chemical resistance, scratch resistance, and adhesive properties:

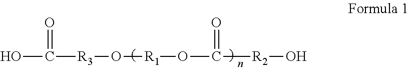

However, the above-mentioned patent documents teach a system in which a silane precursor generally organic-chemically binds to a main chain of the acrylic resin. To apply the above function to a clear coat for cars, crylosilanepolyol, i.e., a precursor of a silane group represented by the structure of the following Formula 2 organic-chemically binds to the main chain of the acrylic resin, such that the reaction can be induced by a reaction mechanism of the following Reaction Schem1:

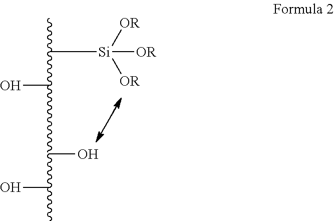

A process of forming a general Si—O—Si bond in the above conventional system will be discussed hereinafter. The reaction is performed in the same manner as in the process shown in the following Reaction Scheme 1. That is, an organic functional silane forms an Si—OH bond by a hydrolysis reaction, and forms an inorganic network of Si—O—Si bonds together with another inorganic reactive group through a dehydration reaction (or self-condensation reaction). Another reversible organic functional silane group performs an organic-chemical binding reaction through the thermal reaction with an acrylic polyol resin.

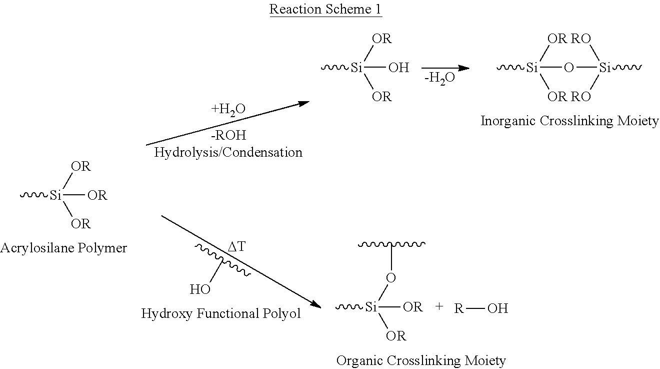

However, it is known that the above reaction mechanism allows a hydroxyl group in the main chain of the acrylic resin to form an Si—O—Si bond in the resin through the reaction between isocyanate and melamine as well as hydrolysis and self-condensation of the silane precursor, resulting in a decrease of storage stability of paints. In general, the biggest problem of the system which organic-chemically binds the silane precursor to the main chain of the acrylic resin resides in a decrease of storage stability. In other words, water produced as a by-product of the self-condensation reaction promotes a hydrolysis reaction of the reaction again, which requires an additive to remove the additionally produced water, and the water serves to decrease storage stability.

In addition, the effect of improving scratch resistance through the network of Si—O—Si bonds is greatly limited as compared to a general acrylic-melamine clear coat. This means that it is difficult to significantly expect the improvement of scratch resistance owing to a silane precursor partially contained in the acrylic resin as a main resin. It is known that the reason for this is that the effect of a crosslinking degree on the acrylic-melamine reaction is larger than the effect of improving the scratch resistance through the network of Si—O—Si bonds.

Moreover, as examples of the conventional technique, there is disclosed Korean Patent Laid-Open Publication No. 2005-115918 entitled “Improved Scratch And Mar Resistant Low Voc Coating Composition”. The coating composition is a curable coating composition, which comprises: (a) a silane functional oligomeric or polymeric material comprising carbamate groups; and (b) a crosslinking component comprising groups that are reactive with the carbamate groups of component (a). A silane functional carbamate resin may be prepared from a mono-ethylenically unsaturated isocyanate monomer. The above patent document teaches a coating composition that has significantly decreased VOC and improved scratch and mar resistance, but the coating composition entails a drawback in that storage stability by self-condensation of silane and improvement of scratch resistance by a pure silane group are not high as expected. In addition, Korean Patent Registration No. 618737 discloses a coating composition having improved adhesion, which is formed from components comprising: (a) 0.01-90 wt % of at least one polysiloxane comprising at least one reactive functional group, the polysiloxane comprising at least one of the following structural units (I): (I) RₙRₘSiO_{(4·n·m)/2}; (b) 2-65 wt % of at least one reactant comprising at least one functional group that is reactive with the reactive functional group of the polysiloxane (a), the reactant being selected from at least one curing agent selected from an aminoplast resin, a polyisocyanate, a blocked isocyanate, a polyepoxide, a polyacid, an anhydride, an amine, a polyol, and mixtures thereof; and (c) at least one compound selected from borates, aluminates, titanates, zirconates, silicates, siloxanes, silanes, and mixtures thereof. Although the aforementioned coating composition exhibits improvements for acid etch resistance and mar and scratch resistance, it involves a problem in that storage stability is lowered by self-condensation of a silane group of a main resin. Moreover, Korean Patent Registration No. 773784 discloses a coating composition containing an acrylic resin, which comprises: 70-100 weight parts of an acrylic resin; 1-20 weight parts of at least one silane compound comprising any one functional group selected from the group consisting of an epoxy group, a vinyl group, an amino group, and an isocyanate group; and 1-10 weight parts of at least one amine compound selected from the group consisting of propyl amine, tertiary amine, ethylene amine, and polyoxyalkylene amine. Although the aforementioned coating composition is excellent in physical properties including abrasion resistance, scratch resistance, and heat resistance, it has a drawback in that its appearance is poor, and moisture in the air or water produced by self-condensation of the silane group causes hydrolysis, thereby lowering a crosslinking degree of a coat film and deteriorating the physical properties of the coat film.

### DISCLOSURE OF INVENTION

### Technical Problem

Accordingly, the present invention has been made in order to solve the above-described problems occurring in the prior art, and it is an object of the present invention is a highly scratch resistant one-part clear coating composition comprising a silane-modified blocked isocyanate for cars, in which a blocked isocyanate curing system comprising a silane functional group is applied besides an acrylic melamine-curing system used as a clear coat system for new cars unlike an acrylic-melamine curing clear coat used as a general clear coat for cars such that the formation of scratches on the surface of a car occurring during the automatic or manual car wash is minimized to maintain initial gloss for as long as possible, thereby maintaining the intrinsic color of the car as well as increasing a degree of consumer's satisfaction with the outer appearance of the car.

Another object of the present invention is to provide a highly scratch resistant one-part clear coating composition comprising a silane-modified blocked isocyanate for cars, in which a silane-modified blocked isocyanate curing system having an excellent storage stability as a substitute for a silane precursor is applied to a main chain of an acrylic resin, such that an increase in the curing density can ensure an improved scratch resistance for cars, unlike a conventional problematic clear coat employing a system in which a silane precursor organic-chemically binds to a main chain of the acrylic resin, and water produced as a by-product of the self-condensation reaction promotes a hydrolysis reaction of the reaction again, which requires an additive to remove the additionally produced water, and storage stability is decreased due to the self-condensation reaction of a silane group in the resin.

Still another object of the present invention is to provide a highly scratch resistant one-part clear coating composition comprising a silane-modified blocked isocyanate for cars, in which improved functionality and mechanical properties of the coat film for automobiles can be implemented by applying an existing curing process system as it is without the necessity of installing a separate curing process or additional equipment.

### Technical Solution

To achieve the above objects, the present invention provides a highly scratch resistant one-part clear coating composition comprising a silane-modified blocked isocyanate for cars, which comprises 35-45 wt % of an acrylic resin, 20-25 wt % of a melamine resin, 5-10 wt % of a silane-modified blocked isocyanate resin, 15-20 wt % of a flowability adjusting resin, 0.2-0.3 wt % of a leveling agent, 1.0-1.5 wt % of a UV absorber, 0.3-0.6 wt % of a UV stabilizer, 2-3 wt % of a catalyst, and 12-15 wt % of a solvent.

In the present invention, the acrylic resin may show a glass transition temperature between −5° C. and −15° C. and may have a viscosity of 500-600 cps. The melamine resin may use a butylated melamine resin to improve reactivity and increase flexibility of a film. The leveling agent may be a silicone-based or acrylic leveling agent.

The silicone-based leveling agent may have a polyether-modified dimethylpolysiloxane structure, and may be one or more selected from the group consisting of polyether-modified polymethylalkylsiloxane, polyether-modified dimethylpolysiloxane, and the like.

The UV absorber may be one or more selected from the group consisting of benzotriazole, benzylidenehydantoin, benzophenone, benzoguanine, and the like.

The solvent may be an aromatic or acetate-based solvent and may be one or a mixture of two or more selected from the group consisting of Butyl acetate, Slovesso #100(Aromatic solvent-100), Butyl Carbitol, and EEP (Ethyl 3-Ethoxypropionate).

In addition, the one-part clear coating composition may form an inorganic network of Si—O—Si bonds by the reaction between the silane-modified blocked isocyanate resin and the acrylic resin.

### Advantageous Effects

According to the present invention, appearance and mechanical properties of a coat film are improved simultaneously by imparting elasticity to the coat film using an urethane bond formed by both an acrylic-melamine reaction and an acrylic-isocyanate reaction and improving a scratch resistance using a silane group boned to the blocked isocyanate. In addition, a highly improved scratch resistance is imparted to the coat film as compared to a conventional one-part acrylic-melamine reaction mechanism, and a silane-modified blocked isocyanate with a relatively low viscosity can be applied to the film to greatly reduce the amount of a solvent used in the paint such that although paint is used in the same amount as in an existing clear coat, the content of solids adhered to a substrate of a car can be increased to considerably reduce the amount of paint used.

### BEST MODE FOR CARRYING OUT THE INVENTION

The present invention to accomplish the above effects is directed to a highly scratch resistant one-part clear coating composition comprising a silane-modified blocked isocyanate for cars. It is to be noted that in the following descriptions, only portions required to understand the present invention will be described and the description of portions other than the above required portions will be omitted to prevent the gist of the present invention from being made unclear.

Hereinafter, a highly scratch resistant one-part clear coating composition comprising a silane-modified blocked isocyanate for cars according to the present invention will be described in further detail.

The present invention is directed to a highly scratch resistant one-part clear coating composition comprising a silane-modified blocked isocyanate for cars, which comprises 35-45 wt % of an acrylic resin, 20-25 wt % of a melamine resin, 5-10 wt % of a silane-modified blocked isocyanate resin, 15-20 wt % of a flowability adjusting resin, 0.2-0.3 wt % of a leveling agent, 1.0-1.5 wt % of a UV absorber, 0.3-0.6 wt % of a UV stabilizer, 2-3 wt % of a catalyst, and 12-15 wt % of a solvent.

The present invention has been made in order to improve the appearance and physical properties including clarity, gloss, acid resistance, scratch resistance, impact resistance, bending resistance and the like of a coat film compared to those of solvent-type one-part clear coating compositions which have been used in the prior art. In the present invention, raw materials for simultaneously improving workability, appearance and mechanical properties are used.

An acrylic resin which is used as a main component in the present invention is preferably a resin which show a glass transition temperature between −5° C. and −15° C. In addition, In view of easy workability, the acrylic resin preferably has a viscosity of 500-600 cps, and the color thereof is preferably as transparent as possible, because it is used for external coating. Also, the acrylic resin used in the present invention preferably has 70 wt % of a solid content and 2.0-3.0 wt % of a hydroxyl group content.

The acrylic resin which is used as a main component in the present invention has the characteristics that it has a viscosity of 500-600 cps, which is considerably low as compared to an existing acrylic resin and shows a glass transition temperature between −5° C. and −15° C. such that a leveling property is excellent due to a high flowability upon the coating of the composition on the surface of a car and simultaneously a strain of a coat film caused by an external impact and scratch can be controlled in a low range due to low glass transition temperature. Further, a deterioration of weather resistance and functionality due to a relatively low glass transition temperature can overcome by simultaneously imparting flexibility and the hardening of the surface through an urethane bond formed by both an acrylic-melamine reaction and an acrylic-isocyanate reaction and inorganic network of Si—O—Si bonds.

In the present invention, the acrylic resin is designed such that a hydroxyl group boned to the acrylic resin can sufficiently participate in the reaction between the melamine and the silane-modified blocked isocyanate. It is a resin capable of imparting a good appearance and sufficient mechanical properties (including adhesive strength, acid resistance, scratch resistance, etc.) to a coat film. The acrylic resin is preferably used in an amount of 35-45 wt %.

If the acrylic resin is used in an amount smaller than the lower limit of the above range, it will not have a minimum curing density necessary for coat film formation, thus making it difficult to realize the various mechanical properties of the film, including adhesive strength, acid resistance and scratch resistance. On the other hand, if the acrylic resin is used in an amount larger than the upper limit of the above range, the appearance of the coat film will be deteriorated, the adjustment of workability will be difficult, and the coat film will become excessively hard, thus adversely affecting the cold chip resistance and adhesive properties of the coat film.

The present invention adopted a melamine resin for the main reaction of the acrylic resin. The melamine resin is a high reactivity resin which reacts with the acrylic resin to form a main skeleton of the reaction. If the melamine resin is used in an amount of less than 20 wt %, a sufficient curing density will not be formed, such that a coat film can be weakened or vulnerable to chemical pollution. On the contrarily, if the melamine resin is used in an amount of more than 25 wt %, the coat film will be excessively hard, resulting in causing a problem of adhesive properties and re-coating.

In addition, the melamine resin may be preferably selected from a butylated resin and a methylated resin to reproduce the physical properties of a coat film. Generally, methylated melamine has high curing reactivity, is hard and has strong chemical resistance compared to butylated melamine. On the other hand, butylated melamine is more flexible and can be advantageous in terms of weather resistance and re-paintability. In the present invention, the butylated melamine is used which can react easily and rapidly due to its high reactivity. In order to suitably use a heat-curing reaction by acrylic melamine, it is important to determine a suitable reaction ratio by understanding each reaction mechanism.

The melamine resin that is used in the present invention is preferably a melamine resin commercially available from BASF Co.

In addition, in the present invention, a silane-modified blocked isocyanate resin is used as a unique curing system besides the melamine resin. The curing system can induce a partial urethane reaction by allowing isocyanate to participate in a reaction other than the acrylic-melamine reaction. Also, an inorganic network of Si—O—Si bonds can be formed by using a silane group substituted for the blocked isocyanate to improve scratch resistance. A silane-modified blocked isocyanate (Silane Modified PUR Crosslinker) is preferably used as a curing agent.

As described above, the present invention is directed to a highly scratch resistant one-part clear coating composition comprising a silane-modified blocked isocyanate for cars. The present invention employs a system in which one of trimer isocyanates is substituted with the silane precursor and a silane functional group binds to a blocked isocyanate group as shown in Reaction Scheme 2 below unlike a method in which a silane precursor synthesized in a main chain of the acrylic resin binds organic-chemically to a curing system of the silane-modified blocked isocyanate, thereby allowing isocyanate to participate in a network reaction.

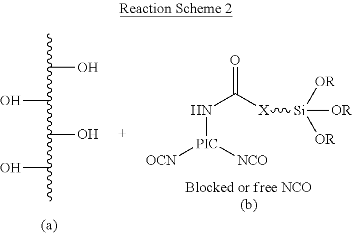

In other words, the present invention is designed such that as shown in Reaction Scheme 2(b) above, when double-substituted SiOR precursors among three isocyanates of a blocked isocyanate (Evonik) forms an Si—OH bond by a hydrolysis reaction, they form an inorganic network of Si—O—Si bonds while being dehydrated through a self-condensation or an SiOR group is activated by heat such that the organic-chemical binding can be performed together with removal of R—OF as shown in Reaction Scheme 1. The present invention has a unique reaction mechanism in which the reaction between a hydroxyl group of the acrylic resin and a functional group of the melamine resin, the reaction between an isocyanate group activated by the dissociation of a blocked group of the silane-modified blocked isocyanate and the hydroxyl group of the acrylic resin, and the Si—O—Si-reaction by hydrolysis and condensation of Si—OR by the silane precursor bonded organic-chemically to the curing system of the silane-modified blocked isocyanate are performed simultaneously.

In the present invention, if the silane-modified blocked isocyanate resin is used in an amount of less than 5 wt %, it will not exhibit an improved scratch resistance by the network of the silane. On the other hand, if the silane-modified blocked isocyanate resin is used in an amount of more than 10 wt %, the reaction ratio of an acrylic-melamine binding will not be balanced, which requires prediction of the use cost.

In addition, the present invention uses a flowability adjusting resin which can control and adjust flowability of a clear coat to facilitate both workability of vertical portions of an automobile and a coating process. Since a problematic excessive flow of the clear coat frequently occurring in at the vertical portions of the automobile adversely affects the appearance and workability of the automobile, its control is required. The clear coating composition of the present invention comprises 15-20 wt % of a flowability adjusting resin to solve such problems such that it has a specific thixotropic property at the time of the paint coating.

If the flowability adjusting resin is used in amount of less than 15 wt %, flowability of a clear coat during the coating work will be deteriorated, resulting in a decrease of workability. On the contrarily, if flowability adjusting resin is used in amount of more than 20 wt %, the content of the acrylic resin as a main resin will be decreased, resulting in failure of formation of sufficient crosslinking density, and thus a reduction in scratch resistance.

Moreover, the leveling agent that is used in the present invention serves to adjust and control the surface tension of the clear coat layer to impart improved wetting properties to the surface so as to provide stable leveling, thus inducing an excellent clarity and surface appearance. The leveling agent is used in an undiluted state in view of a solid content.

The leveling agent that is used in the present invention is preferably used in an amount of 0.2-0.3 wt %. If the leveling agent is used in an amount of less than 0.2 wt %, it cannot exhibit the leveling effect, and if it is used in an amount of more than 0.3 wt %, it will reduce adhesive property to the surface of a material.

Also, the leveling agent that is used in the present invention is preferably a silicone-based or acrylic leveling agent.

Specifically, the silicone-based leveling agent has a polyether-modified dimethylpolysiloxane structure and may be one or more selected from the group consisting of polyether-modified polymethylalkylsiloxane, polyether-modified dimethylpolysiloxane, and the like.

In addition, the acrylic leveling agent that is used in the present invention has an acrylate copolymer structure. If the acrylic leveling agent or the silicone-based leveling agent has an insufficient effect, the acrylic leveling agent and the silicone-based leveling agent may be used in combination.

Moreover, the UV absorber that is used in the present invention serves to absorb light in a wavelength range of 250-400 μm and to change the UV energy to thermal energy. Also, it must be effective even when it is used in a small amount, and it must absorb light in a wavelength range of 290-400 μm and have excellent thermal stability and compatibility. It is preferably used in an amount of 1.0-1.5 wt %. If the UV absorber is used in an amount of less than 1.0 wt %, the ability to absorb UV light can be reduced, and if it is used in an amount of more than 1.5 wt %, it can provide a turbid appearance.

The UV absorber that is used in the present invention may be one or more selected from the group consisting of benzotriazole, benzylidenehydantoin, benzophenone, benzoguanine, and the like.

Specifically, the UV absorber that is used in the present invention is preferably of a powder type which has a structure of Tinuvin #900 [2-(2H-Benzotriazol-2-yl)-6-(1-methyl-1-phenylethyl)-4-(1,1,3,3-tetramethyl butyl)phenol] commercially available from BASF Co., which can be dissolved in acetate or xylene in use.

In addition, the UV stabilizer (liquid hindered amine light stabilizer (HALS)) that is used in the present invention is of a liquid type which has the structure of Tinuvin #292 [Bis(1,2,2,6,6-pentamethyl-4-piperidyl)sebacate] commercially available from BASF Co., and serves to prevent cracks or gloss loss of a coat film caused by UV light. The UV stabilizer serves to remove free radicals produced during a photodecomposition reaction so as to stop a photooxidation reaction. Also, the UV light stabilizer serves to eliminate free radicals produced by the absorption of the UV absorber because amine is hindered in the structure of the UV light stabilizer. The UV light stabilizer serves to eliminate produced free radicals and, at the same time, has the property of being not consumed. The UV stabilizer is preferably used in an amount of 0.3-0.6 wt %. If the UV stabilizer is used in an amount of less than 0.3 wt %, the effect of removing free radicals produced during a photodecomposition reaction so as to stop a photooxidation reaction can be reduced, and if it is used in an amount of more than 0.6 wt %, it can interfere with the activity of the photoinitiator.

In addition, a first catalyst that is used as an important component in the present invention serves to promote the curing reaction between the acrylic-silane-modified blocked isocyanate resin curing systems and is preferably used in an amount of 0.5-1.0 wt %. If the first catalyst is used in an amount of less than 0.5 wt %, the curing reaction does not sufficiently occur, such that the hardness and curing density of the coat film are low, and thus the coat film has weak chemical resistance. On the other hand, if it is used in an amount of more than 1.0 wt %, it can reduce storage stability and increase reaction rate, a compact cured structure cannot be obtained, and the coat film can be excessively hard and can be readily cracked.

A second catalyst serves to activate an —SiOR functional group bonded to the silane-modified blocked isocyanate resin so as to allow the acrylic resin as a main resin with a hydroxyl group. The second catalyst is preferably used in an amount of 1.5-2.0 wt %. Specifically, the catalyst that is used in the present invention is preferably 1% DBTDL (Dibuthyltin Dilaurate) and non-ionic acid catalyst (Dynapol/Evonik).

Also, because the present invention is a coating system that takes into consideration workability, it is required that a co-solvent be used in the same manner as in a general acrylic-melamine curing system. A solvent having good compatibility and solubility is preferably used in an amount of 12-15 wt % in order to impart suitable spray workability. Also, it is important to minimize the content of the solvent by sufficiently considering viscosity during the design of main resins. If the solvent is used in an amount of less than 12 wt %, it will be difficult to wet the surface of a base coat with the paint composition, and the leveling property of the surface can be reduced to make spray coating difficult. On the contrary, if it is used in an amount of more than 15 wt %, it can reduce the total content of diluted solids, so that the efficiency of transfer of the paint composition to a substrate of a car during spray coating can be reduced to increase the consumption of the paint composition, and running of the paint on vertical portions of the car can occur to deteriorate the appearance of the coat film.

The solvent that is used in the present invention may be an aromatic or acetate-based solvent having good compatibility and solubility, and is preferably one or a mixture of two or more selected from the group consisting of Butyl acetate, Slovesso #100(Aromatic solvent-100), Butyl Carbitol, and EEP (Ethyl 3-Ethoxypropionate).

The thermal curing in the present invention is preferably performed by passing the substrate at a conveyor speed of 3.8 m/min at 150° C. for 30 min. If the thermal curing temperature is lower than the lower limit of the above range, an acrylic-melamine reaction by heat will not be occur sufficiently and the blocked isocyanate will not be dissociated, such that a coat film cannot be formed smoothly and the physical properties cannot be reproduced. On the other hand, if the thermal curing temperature is higher than the upper limit of the above range, a coat film will be excessively cured, and thus flexibility of the coat film will not be ensured, resulting in a problem of cold chip resistance, adhesive properties, re-paintability, and the like.

In addition, the clear coat film which is formed on the substrate of a car by the above process preferably has a thickness of 35-45 μm. The thickness of the clear coat film is not necessarily limited to the above thickness range and can be suitably adjusted depending on design conditions.

Hereinafter, the highly scratch resistant one-part clear coating composition comprising a silane-modified blocked isocyanate for cars according to the present invention will be described in detail with reference to examples. It is to be understood, however, that the scope of the present invention is not limited only by the following examples.

### 1. Preparation of One-Part Clear Coating Composition for Cars

According to the composition ratio shown in Table 1 below, a one-part clear coating composition comprising acrylic-melamine-silane-modified blocked isocyanate for cars was prepared.

TABLE 1
(unit: wt %)

| | Composition |
|---|---|
| Components | Ratio |
| Acrylic resin (PPG) | 36.0 |
| Melamine resin (BASF) | 23.0 |
| Silane-modified blocked isocyanate (Evonik) | 7.0 |
| Flowability adjusting resin (acrylic modified SCA) | 15.0 |
| UV absorber (BASF) | 1.4 |
| UV stabilizer (BASF) | 0.4 |
| Leveling agent 1 (BYK) | 0.1 |
| Leveling agent 2 (BYK) | 0.1 |
| Catalyst 1 (DBTDL-1%) | 1.0 |
| Catalyst 2 (Non-ionic acid catalyst) | 2.0 |
| Solvent (Ketone, Acetate, EEP) | 14.0 |

In Table 1 above, two kinds of catalysts were used for reaction activation of the silane-modified blocked isocyanate.

### 2. Manufacture of One-Part Clear Coat Film for Cars

### Example 1

The one-part clear coating composition for cars, prepared according to the method of the above section 1, was applied to a substrate of a car, and then the composition was heat-cured at a temperature of 150±1° C. for 30 minutes, thus forming a clear coat film having a thickness of 40±5 μm (on a dry film basis).

### Comparative Example 1

The one-part clear coating composition for cars, prepared by using a general acrylic-melamine curing system, was applied to a substrate of a car, and then the composition was heat-cured at a temperature of 150±1° C. for 30 minutes, thus forming a clear coat film having a thickness of 40±5 μm (on a dry film basis).

### 3. Evaluation of One-Part Clear Coat Films for Cars

The physical properties of the coat films of Example 1 and Comparative Example 1 formed on the substrate according to the method of the above section 2 were evaluated, and the evaluation results are shown in Table 2 below.

TABLE 2

| | | | Comparative |
|---|---|---|---|
| Test Items | Evaluation Method | Example 1 | Example 1 |
| Viscosity | Ford #4/25° C. | 50 seconds | 50 seconds |
| Diluted | Dried for 3 hr at | 54.0% | 51.0% |
| solid | 105° C. | | |
| content | | | |
| Hardness | Pencil Hardness HB or | HB | HB |
| | more (Mitsubishi) | | |
| Gloss | BYK gloss meter (20 | 89.0 | 89.4 |
| | degree) | | |
| Adhesive | 100,100 cross-cut | Good | Good |
| properties | | | |
| Cold chip | 50 g, N0.7 after −20° | Fair | Fair |
| resistance | C., 3 hr | | |
| Adhesive | Adhesion after | Good | Good |
| property | sedimentation 40° C., 7 days | | |
| in water | | | |
| Acid | 0.1N sulfuric acid | 37° C. | 37° C. |
| resistance | solution, 37° C. or more | | |
| Scratch | Carwash scratch tester | 75.0% | 61.0% |
| resistance | | | |
| Appearance | Wavescan-DOI (CF) | 73 | 71 |

Table 2 above shows the comparison between the physical properties of the clear coat films of Example 1 and Comparative Example 1, all of which are dried by thermal curing. As can be found in Table 2 above, Example 1 and Comparative Example 1 were equal to or greater than an existing curing system in terms of basic hardness, adhesive property, acid resistance, and appearance. In addition, the coat film of Example 1 was relatively high in scratch resistance, which is currently the biggest issue of the appearance of cars, compared to the coat film of Comparative Example 1.

### 4. Preparation of One-Part Clear Coating Compositions Having Varying Contents of Silane-Modified Blocked Isocyanate

According to the components and contents shown in Table 3 below, one-part clear coating compositions for cars of Examples 2 to 4 having varying contents of silane-modified blocked isocyanate were prepared.

TABLE 3
(Unit: wt %)

| Components | Example 2 | Example 3 | Example 4 |
|---|---|---|---|
| Acrylic resin | 36.0 | 36.0 | 36.0 |
| Melamine resin | 24.0 | 23.0 | 22.0 |
| Flowability adjusting | 15.0 | 15.0 | 15.0 |
| agent | | | |
| UV absorber | 1.4 | 1.4 | 1.4 |
| (Tinuvin#928, Ciba Co.) | | | |
| UV stabilizer | 0.4 | 0.4 | 0.4 |
| (Tinuvin#292, Ciba Co.) | | | |
| Leveling agent | 0.2 | 0.2 | 0.2 |
| Catalyst | 3.0 | 3.0 | 3.0 |
| Solvent | 15.0 | 14.0 | 12.0 |
| Silane-modified | 5.0 | 7.0 | 10.0 |
| blocked isocyanate | | | |

As can be seen in Table 3 above, changes in the physical properties and scratches according to the contents of silane-modified blocked isocyanate as a curing gent varying in the amounts of 5, 7, and 10 wt % according to the test method of the following section 5 were found.

### 5. Evaluation of Coat Films Manufactured from One-Part Clear Coating Compositions for Cars Having Varying Contents of Silane-Modified Blocked Isocyanate

Coat films manufactured from the one-part clear coating compositions for cars of Examples 2 to 4 according to the method of the above section 2 were evaluated, and the evaluation results are shown in Table 4 below.

TABLE 4

| | Comparative | Exam- | Exam- | Exam- | |
|---|---|---|---|---|---|
| Test Items | Example 1 | ple 2 | ple 3 | ple 4 | Remarks |
| Initial | 89.3 | 88.9 | 89.1 | 89.1 | BYK |
| gloss(—) | | | | | |
| Gloss(—) | 54.7 | 63.1 | 66.3 | 67.2 | BYK |
| after | | | | | |
| scratching | | | | | |
| Gloss | 61.3 | 70.9 | 74.5 | 75.4 | Automatic car |
| retention | | | | | wash machine |
| (%) | | | | | from AMtek/ |
| | | | | | Kistler |
| Impact | Good | Good | Good | Good | Dupont |
| resistance | | | | | type |

Table 4 above shows the results of evaluating the physical properties of the coat films according to the content of silane-modified blocked isocyanate. As can be seen in Table 4, as the content of silane-modified blocked isocyanate was increased, the bonding density of urethane and silane was increased. Also, it could be found in Table 4 that the coat films of Examples 2 to 4 were higher than the coat film of Comparative Example 1 in gloss after scratching and gloss retention.

### 6. Evaluation of Coat Films Manufactured from One-Part Clear Coating Compositions for Cars Having Varying Contents of Second Catalyst

It was found that changes in the contents of silane-modified blocked isocyanate and catalyst also act as important variables in the present invention. Thus, coat films having a thickness of 40±5 μm (on a dry film basis) were formed on substrates of cars using the composition of Example 3 having varying contents of non-inoic acid catalyst as a second catalyst according to the curing conditions shown in Table 5 below, and the physical properties of the coat films were evaluated. The evaluation results are shown in Table 6 below.

TABLE 5

| Curing conditions | Example 5 | Example 6 | Example 7 | Example 8 |
|---|---|---|---|---|
| Non-ionic acid | 0.5 | 1.0 | 1.5 | 2.0 |
| catalyst(wt %) | | | | |
| Curing | 150 | 150 | 150 | 150 |
| temperature(° C.) | | | | |

TABLE 6

| Example | Example 5 | Example 6 | Example 7 | Example 8 |
|---|---|---|---|---|
| Hardness | HB | HB | HB | HB |
| Gloss | 72.5 | 73.2 | 74.5 | 75.5 |
| retention(%) | | | | |

As can be seen in Tables 5 and 6, there were changes in gloss retention depending on the content of the non-ionic acid catalyst even in case of the coat film formed on the substrate using the composition of Example 3, and gloss retention was increased as the content of the non-ionic acid catalyst was increased in a range of the content of the second catalyst used. It could be found in Table 6 that the coat films of Examples 5 to 8 were higher than the coat film of Comparative Example 1 (see Table 4) in gloss retention.

### 7. Measurement of Changes in Scratch Resistance of Coat Films Having Varying Contents of Flowability Adjusting Resin

As can be seen in Table 7 below, coat films having a thickness of 40±5 μm (on a dry film basis) were formed on substrates of cars using the compositions of Examples 9 to 11 according to the present invention having varying contents of flowability adjusting resin, and the scratch resistances of the coat films were measured. The measurement results are shown in Table 8 below.

TABLE 7
(Unit: wt %)

| Components | Example 9 | Example 10 | Example 11 |
|---|---|---|---|
| Acrylic resin | 40.0 | 36.0 | 34.0 |
| Melamine resin | 23.0 | 23.0 | 23.0 |
| Flowability adjusting | 10.0 | 15.0 | 20.0 |
| resin | | | |
| UV absorber & | 1.8 | 1.8 | 1.8 |
| stabilizer | | | |
| Leveling agent | 0.2 | 0.2 | 0.2 |
| Catalyst | 3.0 | 3.0 | 3.0 |
| Solvent | 15.0 | 14.0 | 12.0 |
| Blocked isocyanate | 7.0 | 7.0 | 7.0 |

TABLE 8

| Example | Example 9 | Example 10 | Example 11 |
|---|---|---|---|
| Gloss retention(%) | 77.4 | 74.4 | 70.5 |
| Flowability (micron) | 36 | 41 | 43 |

In these Examples 9 to 11, the tendency of the scratch resistance according to a change in the content of an acrylic modified flowability adjusting resin was examined. Generally, in case of a clear coat for cars, the coating is performed such that the coat film has a thickness of 35-45 μm or so, and thus the control of flowability of vertical portions of cars is necessarily needed. As in Examples 9 to 11, the improvement of scratch resistance according to a decrease of the contents of the flowability adjusting resin was somewhat confirmed, but it could be found that flowability was deteriorated and thus effective workability could not be ensured. On the contrary, as the content of the flowability adjusting resin was increased, the content of an acrylic resin as a main resin was relatively reduced, and thus a proper curing density was not formed, thereby deteriorating scratch resistance.

While the highly scratch resistant one-part clear coating composition comprising a silane-modified blocked isocyanate for cars according to the preferred embodiments of the present invention have been described, it will be readily appreciated by those skilled in the art that it is merely illustrative of the preferred embodiments of the present invention and various modifications and changes can be made thereto within the technical spirit and scope of the present invention.

### INDUSTRIAL APPLICABILITY

According to the present invention, appearance and mechanical properties of a coat film are improved simultaneously by imparting elasticity to the coat film using an urethane bond formed by both an acrylic-melamine reaction and an acrylic-isocyanate reaction and improving a scratch resistance using a silane group boned to the blocked isocyanate. In addition, the amount of a solvent used in the paint can be greatly reduced such that although paint is used in the same amount as in an existing clear coat, the content of solids adhered to a substrate of a car can be increased to considerably reduce the amount of paint used. Thus, the present invention is expected to be applied to various industrial fields.

1. A highly scratch resistant one-part clear coating composition comprising a silane-modified blocked isocyanate for cars, which comprises 35-45 wt % of an acrylic resin, 20-25 wt % of a melamine resin, 5-10 wt % of a silane-modified blocked isocyanate resin, 15-20 wt % of a flowability adjusting resin, 0.2-0.3 wt % of a leveling agent, 1.0-1.5 wt % of a UV absorber, 0.3-0.6 wt % of a UV stabilizer, 2-3 wt % of a catalyst, and 12-15 wt % of a solvent.

2. The highly scratch resistant one-part clear coating composition of claim 1, wherein the acrylic resin shows a glass transition temperature between −5° C. and −15° C. and has a viscosity of 500-600 cps.

3. The highly scratch resistant one-part clear coating composition of claim 1, wherein the melamine resin is a butylated melamine resin.

4. The highly scratch resistant one-part clear coating composition of claim 1, wherein the leveling agent is a silicone-based or acrylic leveling agent.

5. The highly scratch resistant one-part clear coating composition of claim 4, wherein the silicone-based leveling agent has a polyether-modified dimethylpolysiloxane, and is one or more selected from the group consisting of polyether-modified polymethylalkylsiloxane, polyether-modified dimethylpolysiloxane, and the like.

6. The highly scratch resistant one-part clear coating composition of claim 1, wherein the UV absorber is one or more selected from the group consisting of benzotriazole, benzylidenehydantoin, benzophenone, benzoguanine, and the like.

7. The highly scratch resistant one-part clear coating composition of claim 1, wherein the solvent is a ketone-based or acetate-based solvent and is one or a mixture of two or more selected from the group consisting of Butyl acetate, Slovesso #100(PPG), Butyl Carbitol, and EEP (Ethyl 3-Ethoxypropionate).

8. The highly scratch resistant one-part clear coating composition of any one of claims 1 to 7, wherein the one-part clear coating composition forms an inorganic network of Si—O—Si bonds by the reaction between the silane-modified blocked isocyanate resin and the acrylic resin.
